(19) United States
(12) Patent Application Publication
(10) Pub. No.: US 2015/0210362 A1
(43) Pub. Date: Jul. 30, 2015

(54) SEMI-SUBMERSIBLE PLATFORM WITH A STABILIZING FIN, AND OFFSHORE WAVE POWER PLANT INCORPORATING SUCH A PLATFORM

(71) Applicant: José Antonio RUIZ DIEZ, Octeville Sur Mer (FR)

(72) Inventor: Jose Antonio Ruiz Diez, Octeville Sur Mer (FR)

(21) Appl. No.: 14/411,616

(22) PCT Filed: Jun. 26, 2013
(86) PCT No.: PCT/FR2013/051491

§ 371 Date: Apr. 8, 2015

(30) Foreign Application Priority Data
Jun. 29, 2012 (FR) 12 56299

(51) Int. Cl. B63B 35/44; F03B 13/16; B63B 1/10; B63B 1/12; B63B 1/24

(52) U.S. Cl. CPC B63B 35/44; B63B 1/121; B63B 1/24; B63B 1/107; F03B 13/16; B63B 2035/4466

(57) ABSTRACT

A semi-submersible platform (1), having at least two longitudinal floating box structures (2), the box structures (2) having solid side walls (3, 4) defining a central channel (5) that extends from a bow end (6) to a stern end (7) of the platform (1); at least one beam (10) transversely coupling the box structures (2); and at least one stabilizer aileron (11) that extends transversely below the lower edges (9) of the box structures (2).

The invention concerns a semi-submersible platform intended to be installed at sea and to be used there as infrastructure for a floating installation.

A floating installation, such as a wind power plant or a wave power plant (i.e. one that produces energy from waves), requires that the platform supporting it not only be rigid, but also stable, which naturally poses difficulties because of the waves, which tend to transmit to any floating structure pivotal movements that alternate between longitudinal (pitching) and transverse (rolling).

These movements are to be avoided because of the negative effects that they have for the installation: fatigue (and thus wear) of the mechanical parts, and reduced performance. In the case of a wind turbine, the pitching and rolling movements are harmful to its proper operation, because the mast undergoes significant flexural stresses, and the wind turbine is frequently offset with respect to the direction of the wind. Similarly, in the case of a wave power plant, a lack of stability of the platform causes indiscriminate movements of the motor units, resulting in mechanical fatigue and decreased productive capacity.

A first objective is to propose a semi-submersible platform offering increased stability.

A second objective is to propose a semi-submersible platform offering increased rigidity.

A third objective is to propose a semi-submersible platform having good reliability, so as to minimize maintenance operations.

A fourth objective is to propose a semi-submersible wave power plant having increased energy performance.

A fifth objective is to propose a semi-submersible wave power plant having reduced weight compared to its energy performance.

To that end, firstly, a semi-submersible platform is proposed, comprising:

at least two longitudinal floating box structures having solid side walls defining a central channel that extends from a bow end to a stern end of the platform;

at least one beam transversely coupling the box structures;

at least one stabilizer aileron that extends transversely below the lower edges of the box structures.

The stabilizer aileron, always submerged, maintains the trim of the platform thanks to the weight of the water column on top of it, and it acts as damper, particularly for pitching movements.

The solid nature of the side walls of the box structures enables the water to be directed into the channel, and limits the rolling movements.

Various additional characteristics can be foreseen for this platform, alone or in combination:

the aileron is disposed near the aft end of the box structures;

the aileron is integrated into a transverse beam coupling the box structures;

the beam of which the aileron is a part has a U-shaped transverse cross-section and comprises two side walls that extend from the lower edges of the box structures in the extension thereof;

at least two stabilizing ailerons are provided: one bow aileron, near the forward end, and one stern aileron, near the aft end.

Secondly, a semi-submersible wave power plant is proposed, comprising a platform as presented above, as infrastructure, and a wave energy converting machine mounted on the platform, equipped with at least one float disposed in the channel and enabling the transformation of the wave energy into mechanical energy.

Various additional characteristics can be foreseen for this power plant, alone or in combination:

the float is integral with an articulated arm mounted on a portal frame transversely coupling the box structures;

the articulated arm comprises a connecting rod mounted in rotation on a spindle connected to the frame, and a lever connected to the float, articulated with respect to the connecting rod;

an energy converter is provided, comprising at least one cylinder provided with a piston coupled to the connecting rod;

the spindle of the connecting rod is mounted on a portal frame transversely coupling the box structures;

the wave energy converting machine comprises a transverse row of floats disposed side-by-side in the channel, each one connected to an arm mounted on at least one of the box structures;

upstream from the channel, a funnel shaped opening is provided, delimited at the bottom by a sloped surface;

the sloped surface extends up to the vicinity of the float, upstream therefrom;

the opening is delimited laterally by two side faces that approach each other in the downstream direction;

a breakwater flap articulated on an upstream edge of the sloped surface is provided, between a lowered position in which the flap extends substantially in the extension of the sloped surface, and a raised position in which the flap forms an angle with the sloped surface, thus blocking the opening;

each float is provided with ailerons on lateral faces.

Other objects and advantages of the invention will be seen from the description of one embodiment, provided below with reference to the appended drawings, in which:

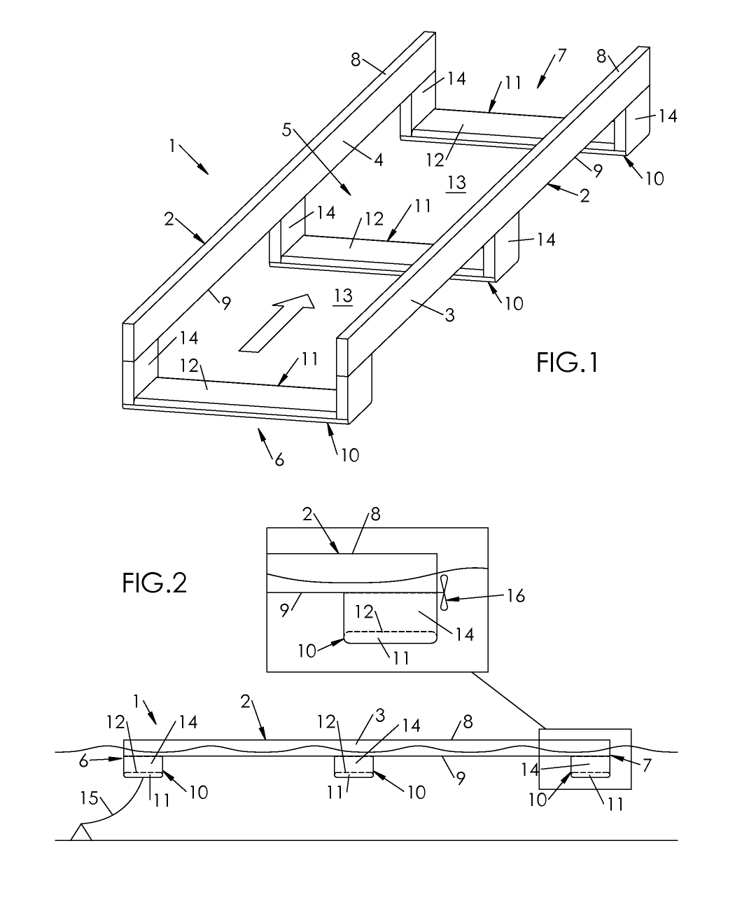

FIG. 1 is a view in perspective showing a semi-submersible platform;

FIG. 2 is a side view showing the platform of FIG. 1 at sea;

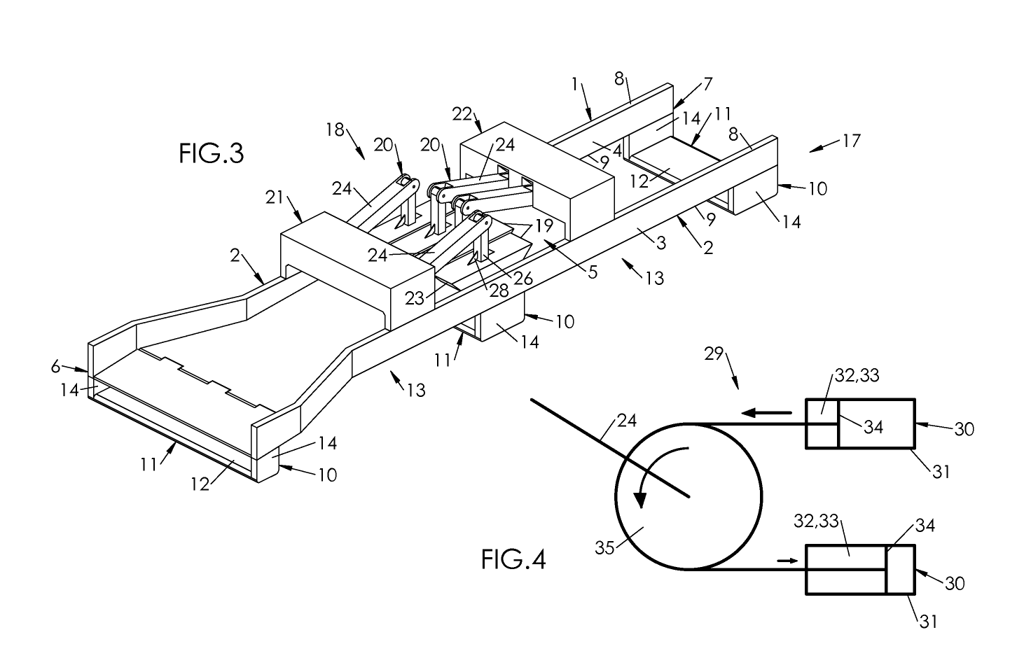

FIG. 3 is a view in perspective showing a wave power generator;

FIG. 4 is a schematic view showing an energy recovery system equipping the power plant of FIG. 3;

FIG. 5 is a top view of the power plant of FIG. 3;

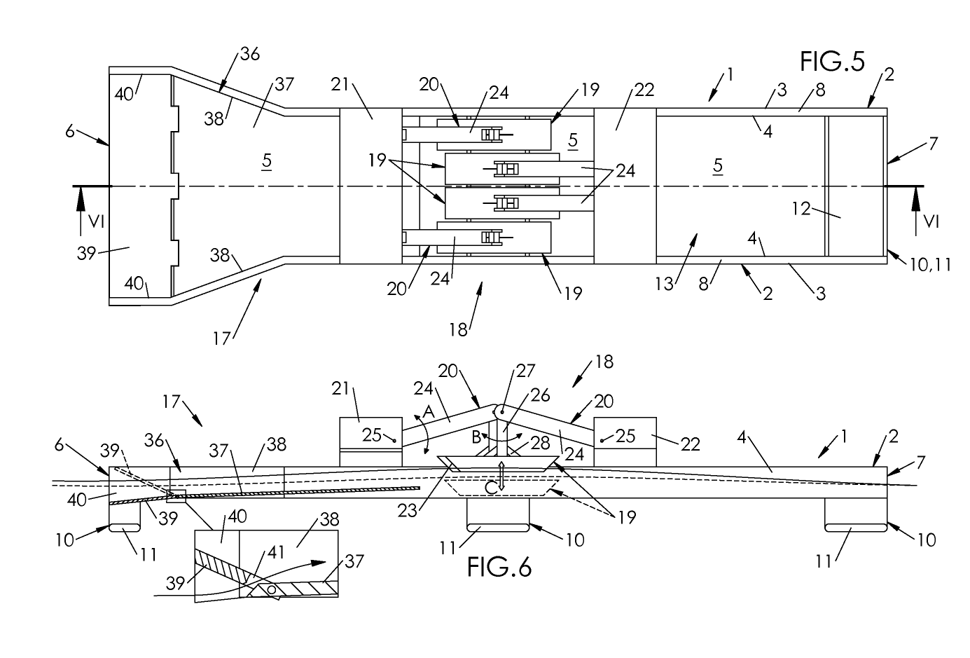

FIG. 6 is a view in cross-section of the power plant of FIG. 5, with a detail inset on a breakwater flap equipping the power plant.

Represented in FIG. 1 is a floating semi-submersible platform 1 intended to serve as infrastructure for an offshore installation, such as a wind power plant, equipped with one or more wind turbines, or as we will see in the example shown below, a wave power plant. Two power plants—one, a wind turbine, and the other, a wave energy converter—can be mounted together on the platform 1.

Said platform 1 comprises a plurality of elongated floating box structures 2, disposed substantially parallel along a longitudinal direction which, when the platform 1 is at sea, corresponds to the principal direction of wave propagation (represented by the arrow in FIG. 1).

In the illustrated example, there are two of said box structures 2 which are parallel-piped in shape, of square or rectangular (as illustrated) cross-section, have a height that is preferably greater than their thickness. The box structures 2 have solid side walls, i.e. outer walls 3 and inner walls 4, said inner walls together as a pair defining a central channel 5 that extends from a bow end 6 to a stern end 7 of the platform 1.

Thanks to the solid side walls 3, 4 of the box structures 2, the seawater is channeled into the channel 5 along the principal direction of wave propagation, which limits the rolling movements of the platform 1.

The box structures 2 have an upper longitudinal edge 8 and an opposite lower longitudinal edge 9 which, in calm to moderately rough seas, can be respectively emerged and immersed.

Each box structure 2 is preferably hollow, and is produced by an assembly of metal plates (for example, steel treated for anticorrosion), composite material or any other material that is sufficiently rigid and resistant to bending forces as well as to corrosion. Each box structure 2 can be stiffened by means of internal ribs, in order to better resist bending stresses, both in the longitudinal plane (particularly when the box structure 2 extends to overhang the crest of a wave, or when it is carried at both ends by two successive crests), as well as in the transverse plane (particularly in the event of local vortex).

Furthermore, each box structure 2 can be compartmentalized to form ballasts that can be at least partially filled with seawater or emptied in order to adjust the flotation line. The filling and emptying of the ballasts can be achieved by means of pumps, preferably actuated automatically.

The platform 1 comprises beams 10 that transversely couple the box structures 2 in order to maintain constant the separation between them and to make the structure rigid. Said beams 10 are in particular dimensioned to withstand the bending stresses engendered by the transverse effort exerted by the pressure of the water on the side walls 3, 4 of the box structures, since said pressure can be different on the outer wall 3 and on the inner wall 4 due to a difference of the water level between the channel 5 and the exterior of the platform 1.

The platform 1 further comprises at least one stabilizer aileron 11 which, at sea, is normally permanently immersed, said aileron 11 preferably extending transversely beneath the lower edges 9 of the box structures 2.

When a single aileron 11 is provided, it is preferably disposed in the vicinity of the stern 7. However, according to a preferred embodiment illustrated in the figures, the platform 1 comprises two stabilizer ailerons 11, that is, a bow aileron 11 disposed at the bow 6, and a stern aileron 11 disposed at the stern 7.

The beams 10 and the ailerons 11 can be dissociated. Thus, an aileron could extend at one end of each box structure 2. However, in a preferred embodiment, illustrated in the figures, each aileron 11 is integrated into a transverse beam 10 coupling the box structures 2, and thus extends transversely from one box structure 2 to the other.

As can be seen in FIG. 1, each aileron 11 has an upper face 12 or upper surface that is substantially flat, parallel and facing the lower longitudinal edges 9 of the box structures 2

The bow and stern ailerons 11, disposed at the ends of the platform 1, provide therebetween an empty space 13 which places the channel 5 in permanent communication with the sea.

It is also possible to equip the platform 1 with an intermediate beam 10, which can form an intermediate aileron 11, similar to the bow and stern ailerons 11 but situated substantially at the center of the platform 1, in order to further increase the stability and rigidity thereof.

As illustrated in FIGS. 1 and 2, each beam 10 having an aileron 11 is U-shaped in transverse cross-section, and comprises two sides 14 that extend from the lower edges 9 of the box structures 2, in the vertical extension thereof, so that the upper surface 12 extends at a distance from the lower edges 9 of the box structures 2 so that the aileron, situated beneath the box structures 2, is always immersed.

This results in the trim of the platform 1 being maintained stable thanks to the weight of the water column on top of the aileron 11, which acts as damper of the movements of the platform 1, particularly for pitching movements. Of course, the presence of two ailerons 11, at the bow and stern, further increases the stability of the platform 1, and particularly, its resistance to pitching.

As can be seen in FIG. 2, the platform 1 can be anchored to the bottom of the ocean by a chain 15 from the platform 1 (preferably being attached at the bow 6, for example to the bow aileron 11). In order to maintain the orientation of the platform 1 substantially constant with respect to the direction of the waves (in the case of a wave power generator), or with respect to the wind direction (in the case of a wind power generator), the platform 1 can also be equipped with a propulsion turbine 16 mounted at the stern 7, thus ensuring that the chain 15 is kept under tension. Said chain 15 will preferably be of a minimum length, so that the chain 15 is hung and extends vertically, thus limiting the range of movement of the platform 1 around its anchoring point, resulting in better security of the platform 1. Multiple anchoring points can be provided.

Structured in this way, the semi-submersible platform 1 offers excellent stability, thanks particularly to the solid side walls 3, 4 of the box structures and to the presence of the ailerons 11, which act as dampers.

The platform 1 is also quite rigid, because the box structures 2 act as longerons and the beams 10 act as reinforcing cross members.

As a result, the platform 1 has good reliability due to the longer working life of its fatigue resistant components. Maintenance operations (consisting primarily of replacing wear parts) are thus minimized.

Thanks to these qualities, the platform 1 can serve as infrastructure for an installation such as a wind power plant or wave power plant. The beams 10 of the platform 1 can serve as support for various components of such an installation (for example, a wind turbine mast).

Represented in FIG. 3 is a floating semi-submersible wave power plant 17 which comprises a wave energy converting machine 18 mounted on a platform 1 as presented above, said platform 1 providing the function of infrastructure for said machine 18.

The wave energy converting machine 18 is equipped with at least one float 19 disposed in the channel 5 to allow the transformation of the energy of the wave into mechanical energy.

As illustrated in FIGS. 3, 5 and 6, the float 19 is connected to an articulated arm 20 mounted on a portal frame 21, 22 transversely coupling the box structures 2 at their upper edges 8.

In the illustrated example, the machine 18 comprises a transverse row of floats 19 disposed side-by-side in the channel 5. In the illustrated example, there are four floats 19 mounted in pairs on two portal frames 21, 22 that are spaced apart. As can be seen in FIG. 5, the floats are grouped as one pair of side floats 19 next to the box structures 2 and mounted on an upstream portal frame 21, and one pair of central floats 19 mounted on a downstream portal frame 22.

The effort generated by the floats 19 at each portal frame 21, 22 can be balanced by adjusting the resistance to rotation of the articulations, in such a way as to minimize the stresses exerted on the platform 1. However, it can be beneficial to cause an imbalance (by adjusting the articulations differently) in order to engender a resonance in the movement of the floats 19, and thus maximize the performance of the machine 18.

Each float 19 is preferably contoured, and for that purpose has a front 23 oriented towards the bow 6 of the platform 1. The articulated arm 20 comprises a connecting rod 24 mounted in rotation on a first spindle 25 connected to the portal frame 21, 22, and a lever 26 connected to the float 19, articulated with respect to the connecting rod 24 around a second spindle 27 of common rotation. For purposes of rigidity, the junction between the lever 26 and the float 19 can be braced by means of angle brackets 28.

The portal frames 21, 22 are preferably dimensioned generously enough to form machine rooms for accommodating and housing the other equipment of the power plant 1, particularly for converting the mechanical wave energy into electric energy.

Indeed, the machine 18 comprises, for each float 19, a converter 29 of the mechanical energy of the float 19 into hydraulic energy. Said converter 29 comprises at least one hydraulic cylinder 30 comprising a cylinder 31 defining a chamber 32 filled with a hydraulic fluid 33 and in which a piston 34 is slidably mounted, coupled to the connecting rod 24. More specifically, as is schematically represented in FIG. 4, the piston 34 is coupled to a wheel 35 connected to the rotation spindle 25 of the connecting rod 24, so that the rotation of the connecting rod 24, caused by an ascending or descending movement of the float 19 (as illustrated in broken lines in FIG. 6), alternately pulls the piston 34 (in the direction of the large straight arrow in FIG. 4) and compresses it (in the direction of the small straight arrow in FIG. 4) by spring effect.

In order to limit the fatigue of the mechanical parts, the hydraulic cylinder 30 is preferably single acting, being arranged so that the fluid 33 is only compressed (and injected into an external fluid system connected to electric generating turbines, possibly stored in the accumulators) when the piston 34 is under tension. In the illustrated example, each converter 29 comprises two hydraulic cylinders 30 functioning in opposition (and both under tension), coupled to the wheel 35, so that each oscillation of the connecting rod 24 (as indicated by the arrow A in FIG. 6) alternatively exerts a pulling force on each of the pistons 34, the wave energy being recovered in this way both during the ascending and descending movements of the float 19.

An energy converter is also preferably mounted on the articulation spindle 27 of each lever 26 with respect to the corresponding connecting rod 24, so that the balancing movements of each float 19 accompanying the wave (as indicated by the arrow B in FIG. 6, on either side of the crest, are also converted into hydraulic (then electric) energy.

As a result of the channel structure of the platform 1, the wave is properly channeled, thus preventing the rolling movements of the floats 19, to the benefit of the energy production of the power plant 1. It will be noted that the openwork structure of the platform 1 makes it possible to obtain good a weight/power ratio.

This energy performance can be increased even more by means of a system for elevating the wave in the channels 5.

To that end, the platform 1 can be modified to have at its bow a funnel shaped opening 36, delimited at the bottom by a face 37 sloped upward in the upstream to downstream direction. This slope can be on the order of a few degrees, which is sufficient to locally slow (and therefore raise) the flow in the channel 5 up to the floats 19.

As can be seen in cross-section in FIG. 6, the sloped surface 37 extends up to the vicinity of the floats 19, upstream therefrom, in order to raise the water level in the channel 5 (as indicated by the solid line) and compared to the water level outside the platform (as indicated by the broken line), without however hindering the piston movement of the floats 19, illustrated by the double arrow C in that figure.

The opening 36 is also delimited laterally by lateral faces 38 which approach each other in the downstream direction, in order to form a local restriction of the width of the channel 5 at the bow 6, which again increases the height of the water level in the channel 5 up to the floats 19.

The amplitude of the wave can be further increased locally at the floats 19 by means of fins provided on the lateral faces of the floats. Said fins, oriented transversely or inclined with respect to the horizontal, divert (and thus slow down) the flow, causing a local increase in the water level in the channel 5.

According to a preferred embodiment illustrated in FIGS. 3, 5 and 6, the platform 1 comprises a mechanism for protection against storms, which goes into action when the sea becomes very rough.

Said mechanism comprises a breakwater flap 39 mounted at the bow 6 of the platform 1. Said flap 39 is articulated on one upstream edge of the sloped surface 37, between:

a lowered position (solid line at the left end of FIG. 6) in which the flap 39 extends substantially as an extension of the sloped surface 37, and

a raised position (broken line at the left end of FIG. 6) in which the flap 39 forms an angle with the sloped surface 37.

In the lowered position, the flap 39 allows free passage of the water towards the channel 5, through the opening 36. This position is occupied by the flap 39 under normal situations (calm or moderately rough sea). As can be seen in FIGS. 3 and 5, the flap 39 is boxed in on either side by straight end sections 40 of the box structures 2, which extend substantially parallel in the extension of the side faces 38.

In the raised position, occupied by the flap 39 when the sea is very rough, the flap 39 closes off the opening 36 in order to limit wave movements in the channel 5 and thus avoid the risks of damaging the machine 18 because of excessive amplitude of the displacement of the floats 19.

As can be seen in FIG. 6, the flap 39 can be raised up to the upper edge 8 of the box structures 2, and even beyond. The flap 39 can be motorized. However, according to a preferred embodiment, the flap 39 can be hollow and can form a ballast which is filled with seawater in order to place the flap 39 in the lowered position, and which, in order to place the flap 39 in the raised position, is emptied in order to thus enable the flap 39 to float, so that it is automatically raised by the sea itself. As can be seen in the detail inset of FIG. 6, the flap 39 can have openings 41 in the vicinity of its articulation on the upstream edge of the sloped surface 37, in such a way as to form, in the raised position, a passage (of limited cross-section) for the seawater (as indicated by the arrow in the inset of FIG. 6) and thus limit the differences in pressure between the channel 5 and the surrounding sea.

In order to further raise the flap 39 with respect to the surrounding sea and limit the risk of high waves surging over the machine 18, the platform 1 can be equipped with a system for adjusting the trim of the platform 1, so as to raise the bow 6 with respect to the stern 7.

This system can comprise a mechanism for partially emptying ballasts integrated into the box structures 2 at the bow end 6, so as to locally lighten (by transfer of mass) the box structures 2 at that end, and thus raise the bow 6 with respect to the stern 7. Said emptying mechanism can be activated automatically, for example by means of buoys that detect wave amplitudes, or upon receipt of a signal produced from a marine weather control center (and possibly relayed by satellite).

1. Semi-submersible platform, comprising:
at least two longitudinal floating box structures having solid side walls defining a central channel that extends from a bow end to a stern end of the platform;
at least one beam transversely coupling the box structures;
at least one stabilizer aileron that extends transversely below the lower edges of the box structures.

2. Platform according to claim 1, characterized in that the aileron is disposed in the vicinity of the stern end.

3. Platform according to claim 2, characterized in that the aileron is connected to a beam coupling the box structures.

4. Platform according to claim 3, characterized in that the beam of which the aileron is a part has a U-shaped transverse cross-section and comprises two side walls that extend from the lower edges of the box structures in the extension thereof.

5. Platform according to claim 1, comprising at least two stabilizer ailerons, i.e. a bow aileron, in the vicinity of the bow end, and a stern aileron, in the vicinity of the stern end.

6. Semi-submersible wave power generator, comprising a platform according to any one of the preceding claims as infrastructure, and a wave energy conversion machine mounted on the platform, equipped with at least one float disposed in the channel to enable the transformation of the wave energy into mechanical energy.

7. Power generator according to claim 6, characterized in that the float is connected to an articulated arm mounted on a portal frame, transversely coupling the box structures.

8. Power generator according to claim 7, characterized in that the articulated arm comprises a connecting rod mounted in rotation on a spindle connected to the portal frame, and a lever connected to the float, articulated with respect to the connecting rod.

9. Power generator according to claim 8, comprising an energy converter comprising at least one hydraulic cylinder provided with a piston coupled to the connecting rod.

10. Power generator according to claim 6, characterized in that the machine comprises a transverse row of floats disposed side-by-side in the channel, each one connected to an articulated arm mounted on a portal frame.

11. Power generator according to claim 6, comprising, upstream of the channel, a funnel shaped opening delimited downwards by a sloped surface.

12. Power generator according to claim 11, characterized in that the sloped surface extends up to the vicinity of the float, upstream thereof.

13. Power generator according to claim 11, characterized in that the opening is laterally delimited by two lateral faces which approach each other in the downstream direction.

14. Power generator according to claim 11, comprising a breakwater flap articulated on an upstream edge of the sloped surface, between a lowered position in which the flap extends substantially in the extension of the sloped surface, and a raised position in which the flap forms an angle with the sloped surface, thus blocking the opening.

15. Power generator according to claim 6, characterized in that each float is provided with fins on the side faces.
